(19) United States
(12) Patent Application Publication
(10) Pub. No.: US 2026/0330955 A1
(43) Pub. Date: Oct. 22, 2026

(54) SYSTEM, METHOD, AND MEDIUM FOR EMERGENCY MONITORING OF PARKED VEHICLES BASED ON INTERNET OF THINGS LARGE MODEL

(71) Applicant: CHENGDU QINCHUAN IOT TECHNOLOGY CO., LTD., Chengdu (CN)

(72) Inventors: Hanshu SHAO, Chengdu (CN); Junyan ZHOU, Chengdu (CN); Guobin LUO, Chengdu (CN)

(73) Assignee: CHENGDU QINCHUAN IOT TECHNOLOGY CO., LTD., Chengdu (CN)

(21) Appl. No.: 19/691,732

(22) Filed: May 29, 2026

(30) Foreign Application Priority Data
May 6, 2026 (CN) 202610602810.7

(51) Int. Cl. G08B 21/18; G06V 10/62; G06V 10/70; G06V 20/52; G08B 5/38; G08B 21/02; G16Y 40/10; G16Y 40/50

(52) U.S. Cl. CPC G08B 21/182; G06V 10/62; G06V 10/70; G06V 20/52; G08B 5/38; G08B 21/02; G16Y 40/10; G16Y 40/50; G06V 2201/08

(57) ABSTRACT

Provided is system, method, and medium for emergency monitoring of parked vehicles based on an IoT large model. The method is executed by an emergency supervision management platform, and the method includes: acquiring temperature data of a target vehicle in a preset space by a temperature-measuring camera according to a preset acquisition period; constructing a temperature distribution cloud map of the target vehicle based on the temperature data; determining temperature information of a battery pack region of the target vehicle based on the temperature distribution cloud map; determining a thermal risk coefficient of the target vehicle based on the temperature information; determining a risk vehicle based on the thermal risk coefficient; determining an early warning frequency based on the thermal risk coefficient of the risk vehicle and the temperature data of the risk vehicle; and controlling a warning lamp in a monitoring room to flash at the early warning frequency.

### CROSS-REFERENCE TO RELATED APPLICATIONS

This application claims priority to Chinese Patent Application No. 202610602810.7, filed on May 6, 2026, the contents of which are hereby incorporated by reference to its entirety.

### TECHNICAL FIELD

The present disclosure generally relates to a field of vehicle monitoring, and in particular to a system, a method, and a medium for emergency monitoring of parked vehicles based on an Internet of Things (IoT) large model.

### BACKGROUND

With the rapid increase in the number of new energy vehicles, the risk of spontaneous combustion caused by internal aging, external short circuits, or thermal runaway of the high-energy-density batteries equipped in these vehicles during parking is becoming increasingly prominent. Existing parking lots generally lack the capability for real-time perception of the temperature state of vehicle batteries and early warning. The existing parking lots cannot perform effective and timely intervention before thermal runaway of the vehicles occurs. The existing parking lots pose a significant fire hazard.

Therefore, there is an urgent need to provide a system, a method, and a medium for emergency monitoring of parked vehicles based on an Internet of Things (IoT) large model. The system, the method, and the medium can realize real-time monitoring and effective early warning of the thermal runaway risk of vehicles by monitoring the battery temperature of parked vehicles, so that intervention measures can be taken as early as possible.

### SUMMARY

One or more embodiments of the present disclosure provide a system for emergency monitoring of parked vehicles based on an Internet of Things (IoT) large model. The system comprises an emergency supervision management platform, and the emergency supervision management platform is configured to execute a method for emergency monitoring of parked vehicles based on the IoT large model.

One or more embodiments of the present disclosure provide a method for emergency monitoring of parked vehicles based on an IoT large model. The method is executed by an emergency supervision management platform of the system for emergency monitoring of parked vehicles based on the IoT large model, and the method comprises: collecting, based on at least one temperature-measuring camera, temperature data of at least one target vehicle in a preset space according to a preset acquisition period; constructing, based on the temperature data, a temperature distribution cloud map of the at least one target vehicle; determining, based on the temperature distribution cloud map, temperature information of at least one battery pack region of the at least one target vehicle; determining, based on the temperature information, a thermal risk coefficient of the at least one target vehicle; determining, based on the thermal risk coefficient, at least one risk vehicle; determining, based on the thermal risk coefficient of the at least one risk vehicle and the temperature data of the at least one risk vehicle, an early warning frequency; and controlling at least one warning lamp in a monitoring room to flash at the early warning frequency.

One or more embodiments of the present disclosure provide a non-transitory computer-readable storage medium storing computer instructions, when a computer reads the computer instructions in the storage medium, the computer executes the method for emergency monitoring of parked vehicles based on the IoT large model.

### BRIEF DESCRIPTION OF THE DRAWINGS

The present disclosure will be further described by way of exemplary embodiments. These exemplary embodiments will be described in detail with reference to the drawings. These embodiments are not limiting. In these embodiments, the same reference numerals denote the same structures, wherein:

FIG. 1 is a schematic diagram illustrating a platform structure of a system for emergency monitoring of parked vehicles based on an Internet of Things (IoT) large model according to some embodiments of the present disclosure;

FIG. 2 is a flowchart illustrating an exemplary process for a method for emergency monitoring of parked vehicles based on an IoT large model according to some embodiments of the present disclosure;

FIG. 3 is a schematic diagram illustrating an exemplary process for determining a thermal risk coefficient according to some embodiments of the present disclosure;

FIG. 4 is a flowchart illustrating an exemplary process for sending an early warning according to some embodiments of the present disclosure;

FIG. 5 is a flowchart illustrating an exemplary process for collecting temperature data of at least one potential risk vehicle according to some embodiments of the present disclosure.

### DETAILED DESCRIPTION

A brief introduction to the figures to be used in the description of the embodiments will be made below. The figures do not represent all embodiments.

As used herein, the terms “system”, “device”, “unit”, and/or “module” are a manner for distinguishing different components, elements, parts, portions, or assemblies of different levels. However, if other terms can achieve the same purpose, the terms may be replaced by other expressions.

Unless the context clearly indicates otherwise, the terms “a”, “an”, “one”, and/or “the”, or the like, do not specifically refer to the singular, but may also include the plural. Generally speaking, the terms “comprises” and “includes” merely indicate the inclusion of explicitly identified steps and elements, and these steps and elements do not constitute an exhaustive list, and the method or device may also include other steps or elements.

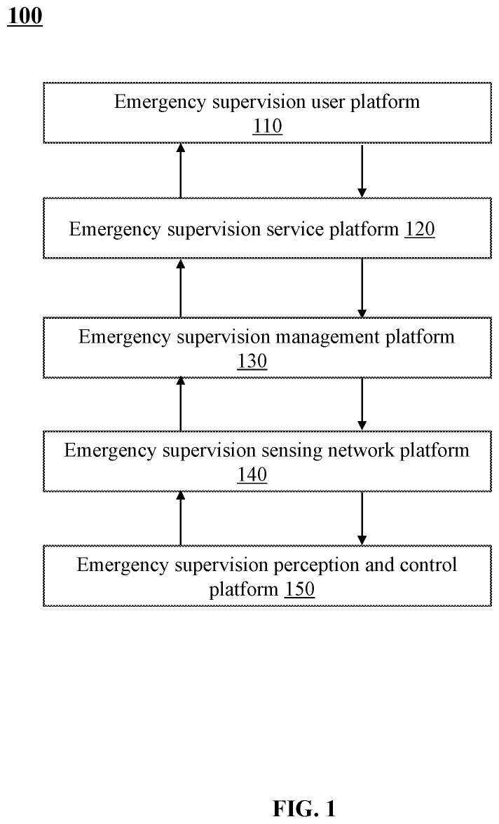

FIG. 1 is a schematic diagram illustrating a platform structure of a system for emergency monitoring of parked vehicles based on an Internet of Things (IoT) large model according to some embodiments of the present disclosure.

In some embodiments, as shown in FIG. 1, the system for emergency monitoring of parked vehicles based on an IoT large model 100 comprises an emergency supervision user platform 110, an emergency supervision service platform 120, an emergency supervision management platform 130, an emergency supervision sensing network platform 140, and an emergency supervision perception and control platform 150.

The emergency supervision user platform 110 refers to a platform for comprehensively coordinating emergency supervision by a superior supervision department. In some embodiments, the emergency supervision user platform comprises user terminals, e.g., mobile devices, computers, or other devices having input and/or output functions, or any combination thereof.

The emergency supervision service platform 120 refers to an interactive service platform for receiving and transmitting emergency supervision data.

In some embodiments, the emergency supervision service platform interacts upwardly with the emergency supervision user platform and interacts downwardly with the emergency supervision management platform.

In some embodiments, the emergency supervision service platform comprises a communication terminal.

The communication terminal refers to a device or software configured to achieve real-time information interaction. For example, the communication terminal may be a wireless phone, a video monitor, a multimedia computer, or the like.

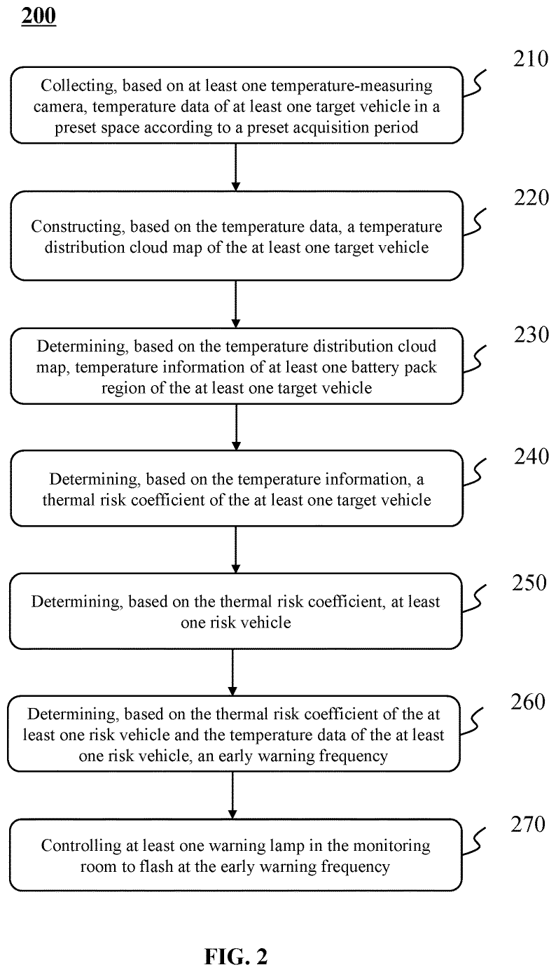

The emergency supervision management platform 130 refers to a comprehensive platform configured to process and manage emergency supervision data of parked vehicles. In some embodiments, the emergency supervision management platform is configured to execute a method for emergency monitoring of parked vehicles based on an IoT large model. More descriptions regarding the method may be found elsewhere in the present disclosure (e.g., FIGS. 2-5 and related descriptions thereof).

In some embodiments, the emergency supervision management platform may comprise a processor and/or a server, a data center, or the like. The data center is configured with a storage device.

The emergency supervision sensing network platform 140 refers to a platform configured to transmit emergency supervision-related sensing data or information, and comprises a router and a gateway, or the like.

In some embodiments, the emergency supervision sensing network platform interacts upwardly with the emergency supervision management platform and interacts downwardly with the emergency supervision perception and control platform.

The emergency supervision perception and control platform 150 refers to a platform for emergency supervision data collection and execution of instructions.

In some embodiments, the emergency supervision perception and control platform may comprise camera devices (e.g., a temperature-measuring camera, a common visible light camera), warning devices (e.g., a warning lamp), or the like.

More descriptions regarding the above-mentioned platforms may be found elsewhere in the present disclosure (e.g., FIGS. 2-5 and related descriptions thereof).

It should be noted that the above description of the system for emergency monitoring of parked vehicles based on an IoT large model 100 is merely for convenience of description and does not limit the present disclosure to the scope of the illustrated embodiments. It can be understood that, for those skilled in the art, after understanding the principle of the system, they can arbitrarily combine the modules, or form subsystems to be connected to other modules, without departing from the principle. In some embodiments, the modules may share a storage module, and the modules may also each have their own respective storage modules. Such variations are all within the protection scope of the present disclosure.

FIG. 2 is a flowchart illustrating an exemplary process of a method for emergency monitoring of parked vehicles based on an IoT large model according to some embodiments of the present disclosure. As shown in FIG. 2, a process 200 comprises the following steps. In some embodiments, the process 200 may be executed by the emergency supervision management platform 130.

Step 210, collecting, based on at least one temperature-measuring camera, temperature data of at least one target vehicle in a preset space according to a preset acquisition period.

The temperature-measuring camera refers to a camera device capable of measuring a surface temperature of an object. For example, an infrared thermal imaging camera.

The preset acquisition period refers to a pre-set time interval between two adjacent temperature data collections and may be pre-set manually or by default by a system. For example, 3 s, 5 s.

The preset space refers to a pre-set space where vehicle thermal runaway risk monitoring is required. For example, an underground parking lot.

The target vehicle refers to a stationary vehicle that enters and is parked in the preset space.

In the present disclosure, the application scenario of the emergency monitoring of parked vehicles based on an IoT large model is mainly vehicle thermal runaway risk monitoring. The thermal runaway risk refers to a potential danger of fire caused by out-of-control vehicle batteries (e.g., spontaneous combustion or explosion). That is, the target vehicle is merely a new energy vehicle (including a pure electric vehicle, a hybrid vehicle, or other vehicles that have battery packs).

The temperature data refers to temperature-related data of the target vehicle. The temperature data may comprise temperature values of a plurality of different positions of the target vehicle, e.g., a temperature of a vehicle chassis, a temperature of a vehicle exhaust pipe.

In some embodiments, the at least one temperature-measuring camera performs a scanning temperature measurement on a surface of the at least one target vehicle once every preset acquisition period, and each pixel corresponds to a temperature value. The temperatures of a plurality of positions obtained by the at least one temperature-measuring camera in a single acquisition of the at least one target vehicle may be represented in a preset form (e.g., a sequence, a matrix), thereby constituting the temperature data corresponding to the acquisition. That is, the temperature data corresponding to a single acquisition may be represented as a temperature sequence or a temperature matrix, or the like. The emergency supervision management platform can directly obtain the temperature data of the at least one target vehicle measured and uploaded by the at least one temperature-measuring camera.

Step 220, constructing, based on the temperature data, a temperature distribution cloud map of the at least one target vehicle.

The temperature distribution cloud map refers to an image that intuitively displays a surface temperature distribution of the target vehicle.

For example, the temperature distribution cloud map may be a pseudo-color image, which uses different colors to represent different temperature values. Merely by way of example, temperatures below 20° C. are displayed as blue, temperatures from 20° C. to 60° C. are displayed as green, and temperatures above 60° C. are displayed as red.

In some embodiments, at every preset acquisition period, the emergency supervision management platform may visually render the temperature data from a single acquisition and obtain the temperature distribution cloud map corresponding to the single acquisition.

Step 230, determining, based on the temperature distribution cloud map, temperature information of at least one battery pack region of the at least one target vehicle.

The battery pack region refers to a physical region at a bottom of the target vehicle configured to accommodate a battery.

The temperature information may include temperature distribution and thermal gradient variation. The temperature distribution refers to a spatial distribution of temperature values at respective points of the battery pack region, and the thermal gradient variation refers to a variation rate and a variation direction of temperature values in space, i.e., a variation amount of temperature within a unit distance.

In some embodiments, the emergency supervision management platform may utilize technologies such as spatial registration to pixel-level superimpose the temperature distribution cloud map of the target vehicle and a visible light reference map, thereby allowing temperatures of various regions of the vehicle to be intuitively mapped out on a vehicle structural contour provided by the visible light reference map. Therefore, the emergency supervision management platform may obtain the temperature distribution of the battery pack region by directly cropping the battery pack region. The visible light reference map refers to an image collected by an ordinary visible light camera and used to provide spatial position and contour references.

In some embodiments, the emergency supervision management platform may obtain the thermal gradient variation by performing spatial differential calculation on the data of the temperature distribution of the battery pack region. For example, the emergency supervision management platform may determine a temperature difference between each pixel point and an adjacent pixel point along a preset positive direction in the temperature distribution of the battery pack region, divide the temperature difference by an actual physical distance between the two pixel points, thereby obtaining a thermal gradient value corresponding to each pixel point, to constitute the thermal gradient variation of the battery pack region. The temperature difference is defined as a temperature value of an adjacent pixel point along the preset positive direction minus a temperature value of the current pixel point. The preset positive direction may be set manually or use the system default.

Step 240, determining, based on the temperature information, a thermal risk coefficient of the at least one target vehicle.

The thermal risk coefficient refers to a numerical value that quantifies a thermal runaway risk level of the target vehicle. The thermal risk coefficient may be represented by a numerical value from 0 to 100, wherein the larger the numerical value, the greater battery thermal runaway risk.

In some embodiments, the emergency supervision management platform may determine the thermal risk coefficient based on the temperature information through a plurality of manners. For example, the emergency supervision management platform may determine the thermal risk coefficient based on the temperature distribution and the thermal gradient variation by querying a first preset table.

The first preset table includes corresponding relationships between the temperature distribution, the thermal gradient variation, and the thermal risk coefficient. The first preset table may be constructed manually based on experimental data. For example, battery packs of different models and different health states (e.g., different remaining battery capacity, different remaining electrolyte capacity) may be selected as experimental objects. In a laboratory environment, various fault scenarios that may cause thermal runaway (e.g., internal short circuit, overcharge/overdischarge, cooling system failure) are simulated. Experimental temperature distribution and experimental thermal gradient variation of the experimental objects are continuously monitored, and corresponding thermal risk coefficients are marked based on experience, thereby constructing the first preset table.

Merely by way of example, if an experimental temperature distribution of the experimental object indicates that temperatures of more than 90% of the pixel points in the battery pack region are less than or equal to 45° C., and an experimental thermal gradient variation indicates that temperature differences between more than 90% of the pixel points and the adjacent pixel points along the preset positive direction are less than or equal to 0.5° C., then it indicates that the experimental object is in a normal charge-discharge state and is determined as a low risk (e.g., the thermal risk coefficient is marked as 0 to 30 points). If the experimental temperature distribution of the experimental object indicates that temperatures of more than 90% of the pixel points in the battery pack region are greater than 45° C. and less than or equal to 65° C., and/or the experimental thermal gradient variation indicates that temperature differences between more than 90% of the pixel points and the adjacent pixel points along the preset positive direction are greater than 0.5° C. and less than or equal to 2° C., then it indicates that the experimental object is in a controllable state with abnormal temperature rise or local hotspots, and is determined as a medium risk (e.g., the thermal risk coefficient is marked as 31 to 70 points). If the experimental temperature distribution of the experimental object indicates that temperatures of more than 90% of the pixel points in the battery pack region are greater than 65° C., and the experimental thermal gradient variation indicates that temperature differences between more than 90% of the pixel points and the adjacent pixel points along the preset positive direction are greater than 2° C., then it indicates that the experimental object is in a thermal runaway state and is determined as a high risk (e.g., the thermal risk coefficient is marked as 71 to 100 points).

In some embodiments, the emergency supervision management platform may determine an environment reference temperature of the target vehicle based on the temperature data of at least one first reference vehicle of the target vehicle, wherein the first reference vehicle is another target vehicle within a first neighborhood range of the target vehicle; determine abnormal temperature information of the at least one battery pack region of the target vehicle based on the environment reference temperature and the temperature information of the at least one battery pack region; and determine the thermal risk coefficient of the target vehicle based on the abnormal temperature information of the at least one battery pack region.

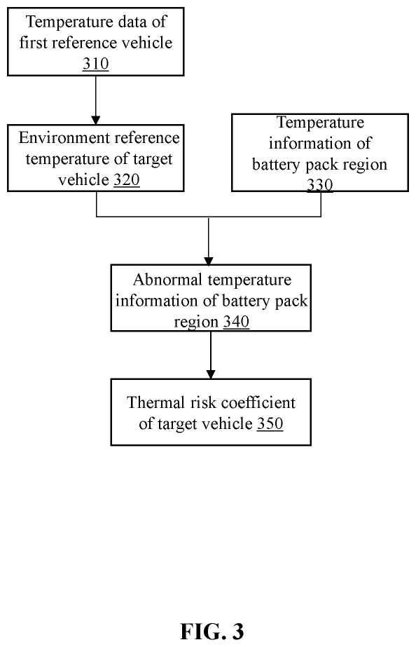

More descriptions regarding this portion may be found elsewhere in the present disclosure (e.g., FIG. 3 and related descriptions thereof).

Step 250, determining, based on the thermal risk coefficient, at least one risk vehicle.

The risk vehicle refers to the target vehicle determined to have a thermal runaway risk.

In some embodiments, the emergency supervision management platform may determine the target vehicle whose thermal risk coefficient is greater than a first risk threshold as the risk vehicle. The first risk threshold may be set manually based on historical experience.

Step 260, determining, based on the thermal risk coefficient of the at least one risk vehicle and the temperature data of the at least one risk vehicle, an early warning frequency.

The early warning frequency refers to a frequency for early warning of a thermal runaway risk of a vehicle. In some embodiments, the early warning frequency may be a flashing frequency of a warning lamp in a monitoring room within a unit time. The monitoring room refers to a place where management personnel are located within the preset space.

In some embodiments, the emergency supervision management platform may determine the early warning frequency based on the thermal risk coefficient of the risk vehicle and the temperature data of the risk vehicle by querying a second preset table.

The second preset table includes corresponding relationships between the thermal risk coefficient of the risk vehicle, the temperature data of the risk vehicle, and the early warning frequency. The greater the thermal risk coefficient of the risk vehicle and the higher the temperature of the risk vehicle, the faster the early warning frequency. The second preset table may be constructed manually based on historical data.

Step 270, controlling at least one warning lamp in the monitoring room to flash at the early warning frequency.

In some embodiments, the emergency supervision management platform may generate and issue a control command that includes the early warning frequency, to control the at least one warning lamp in the monitoring room to flash at the early warning frequency.

In some embodiments of the present disclosure, real-time full-domain monitoring is performed on the target vehicle through the temperature-measuring camera, a monitoring region is accurately corresponded to a location of the battery pack region, and temperature information of the battery pack region is converted into a single-value index that is gradable and comparable by using the thermal risk coefficient. Once a set risk threshold is exceeded, the warning lamp may be controlled to flash at the early warning frequency to achieve early identification and intervention.

FIG. 3 is a schematic diagram illustrating an exemplary process for determining a thermal risk coefficient according to some embodiments of the present disclosure.

In some embodiments, as shown in FIG. 3, the emergency supervision management platform may determine, based on the temperature data 310 of at least one first reference vehicle of the target vehicle, an environment reference temperature 320 of the target vehicle, wherein the first reference vehicle is another target vehicle within a first neighborhood range of the target vehicle; determine, based on the environment reference temperature 320 and the temperature information 330 of the at least one battery pack region, abnormal temperature information 340 of the at least one battery pack region of the target vehicle; and determine, based on the abnormal temperature information 340 of the at least one battery pack region, a thermal risk coefficient 350 of the target vehicle.

More descriptions regarding the target vehicle, the temperature data, the battery pack region, the temperature information, and the thermal risk coefficient may be found elsewhere in the present disclosure (e.g., FIG. 2 and related descriptions thereof).

The first reference vehicle refers to a neighboring vehicle used to provide an environment temperature reference for the target vehicle. In some embodiments, the first reference vehicle of the target vehicle may be another target vehicle within the first neighborhood range of the target vehicle. The first neighborhood range may be set manually or use the system default (e.g., a circular region within a first preset radius range (e.g., 5 m) centered on the target vehicle).

The environment reference temperature refers to a reference temperature value that uses temperature of surrounding vehicles of the target vehicle as a reference standard.

In some embodiments, the emergency supervision management platform may determine an average temperature of the battery pack region of the first reference vehicle based on the temperature information of the battery pack region of the first reference vehicle, wherein the average temperature is an average value of temperatures of the plurality of pixel points in the battery pack region; perform a weighted sum on the average temperatures of the battery pack regions of all the first reference vehicles of the target vehicle; and determine the result of the weighted sum as the environment reference temperature of the target vehicle. The weight corresponding to the first reference vehicle is negatively correlated with the distance between the first reference vehicle and the target vehicle.

The abnormal temperature information refers to abnormal information in the temperature information of the battery pack region. In some embodiments, the abnormal temperature information may include an abnormal hotspot and an abnormal thermal gradient region.

The abnormal hotspot refers to an isolated point in the battery pack region where the temperature is significantly higher than a temperature of a surrounding region.

The abnormal thermal gradient region refers to a collection region of pixel points in the battery pack region where a thermal gradient value is abnormal.

In some embodiments, the emergency supervision management platform may determine the abnormal temperature information in various manners based on the environment reference temperature and the temperature information.

For example, based on the temperature information, the emergency supervision management platform may determine, as an abnormal hotspot, pixel points in the battery pack region where an absolute value of a difference between the temperature of the pixel points and the environment reference temperature exceeds a temperature difference threshold; and determine, as an abnormal thermal gradient region, a region formed by pixel points where the thermal gradient value exceeds a gradient threshold. The temperature difference threshold and the gradient threshold may be set manually based on historical experience. The region formed by pixel points may be represented by a connected domain formed by the pixel points according to spatial adjacency relationships.

In some embodiments, the abnormal temperature information may further include a diffusion path of an abnormal hotspot. The emergency supervision management platform may further determine the diffusion path of the abnormal hotspot based on the plurality of abnormal hotspot centers corresponding to the plurality of time points.

The diffusion path refers to a spatial displacement trajectory of the abnormal hotspot changing over time.

In some embodiments, the diffusion path may be represented by a sequence formed by a plurality of spatiotemporal coordinate points of the plurality of abnormal hotspots corresponding to the plurality of time points, arranged chronologically, wherein spatiotemporal coordinate points with earlier times are ranked earlier. Each spatiotemporal coordinate point is formed by a spatial position coordinate of the abnormal hotspot center and a corresponding time. Merely by way of example, the diffusion path is: [(X1, Y1, T1), (X2, Y2, T2), . . . , (Xn, Yn, Tn)], wherein (Xn, Yn, Tn) is a n-th spatiotemporal coordinate point, indicating that a spatial position coordinate of the abnormal hotspot center at time Tn is (Xn, Yn), and the time T(n−1) is before the time Tn. The spatial position coordinate may be represented by pixel coordinates.

In some embodiments, the plurality of time points may comprise the plurality of historical time points and/or one or more future time points.

The historical time point refers to a time point before a current time point.

The future time point refers to a time point after a current time point.

In some embodiments, the plurality of time points may be selected at uniform intervals. For example, a historical time point may be selected, or a future time point may be set every 5 s.

In some embodiments, the plurality of time points may also be determined based on the temperature information of the battery pack region. For example, for each historical moment, an average value of temperatures of a plurality of pixel points in the battery pack region is determined as an average temperature of the battery pack region based on the temperature distribution of the battery pack region; and a historical moment where the average temperature changes abruptly (e.g., a change amount of the average temperature exceeds a preset change amount threshold) is determined as a historical time point.

The abnormal hotspot center refers to a central representative point of all the abnormal hotspots in the battery pack region at the same time.

In some embodiments, the emergency supervision management platform may determine an abnormal hotspot center in various manners. For example, the emergency supervision management platform may determine an abnormal hotspot with the highest temperature among all the abnormal hotspots in the battery pack region at the same historical time point as the abnormal hotspot center.

In some embodiments, the plurality of time points may comprise the plurality of historical time points and one or more future time points. The emergency supervision management platform may further determine one or more abnormal hotspot centers corresponding to the one or more future time points via a prediction model based on the plurality of abnormal hotspot centers corresponding to the plurality of historical time points, wherein the prediction model is a machine learning model.

The prediction model refers to a model configured to predict the abnormal hotspot centers of the future time points.

In some embodiments, the prediction model is a machine learning model. For example, a Long Short-Term Memory (LSTM) model.

In some embodiments, the input of the prediction model includes the plurality of abnormal hotspot centers corresponding to the plurality of historical time points, and the output of the prediction model includes one or more abnormal hotspot centers corresponding to one or more future time points. The data for the input and output of the prediction model may both be spatiotemporal coordinate points corresponding to the abnormal hotspot centers.

In some embodiments, the emergency supervision management platform may train the prediction model based on a plurality of training samples with training labels.

The training samples may be obtained based on historical data, and the training labels may be annotated manually based on historical data. A set of training samples used in a single training may include a plurality of historical abnormal hotspot centers corresponding to a plurality of first sample historical time points, and the training labels corresponding to the set of training samples are one or more historical abnormal hotspot centers corresponding to one or more second sample historical time points. The first sample historical time points are before the second sample historical time points.

The data used for training the prediction model may both be historical spatiotemporal coordinate points corresponding to the historical abnormal hotspot centers. In some embodiments, the emergency supervision management platform may input the training samples into an initial prediction model; construct a loss function based on the training labels and output results of the initial prediction model; iteratively update parameters of the initial prediction model based on the loss function; and after an iteration termination condition is satisfied, terminate iteration to obtain a trained prediction model. The method of iteratively updating may include but is not limited to a gradient descent method. The iteration termination condition may be convergence of the loss function or that a number of iterations reaches a threshold.

In some embodiments of the present disclosure, determining the abnormal hotspot centers of one or more future time points via the prediction model can more precisely and rapidly determine the positions of the abnormal hotspot centers of the one or more future time points, thereby facilitating precise and rapid determination of the abnormal hotspot centers of the battery pack region at the plurality of future time points, and improving determination speed and accuracy of the diffusion path.

In some embodiments, the emergency supervision management platform may determine, based on the plurality of abnormal hotspot centers corresponding to the plurality of time points, the diffusion path of the abnormal hotspot. For example, the emergency supervision management platform may arrange the plurality of spatiotemporal coordinate points of the abnormal hotspots corresponding to the aforementioned plurality of time points into a sequence based on time, as the diffusion path of the abnormal hotspot center. For another example, the emergency supervision management platform may adopt a path fitting algorithm (e.g., least squares method) to smoothly connect the abnormal hotspot centers corresponding to the aforementioned plurality of time points and use the connecting line as the diffusion path of the abnormal hotspot center. The plurality of time points may include the plurality of historical time points and one or more future time points or may merely include the plurality of future time points.

In some embodiments of the present disclosure, by using the abnormal hotspot centers of the plurality of time points (including historical time points and one or more future time points), the diffusion path of the abnormal hotspot in the battery pack region can be predicted, thereby predicting the development direction of the risk. This can allow for the implementation of more targeted intervention measures, the provision of dynamic early warning for the thermal risk of parked vehicles, and the optimization of early warning resources utilization.

In some embodiments, the emergency supervision management platform may determine the number of abnormal hotspots and determine the area proportion of the abnormal thermal gradient region in the battery pack region. The emergency supervision management platform may then perform a weighted summation calculation of dimensionless values for the two, subject the weighted summation result to normalization processing, and map the normalized result to a numerical range corresponding to the thermal risk coefficient. The weights may be preset manually based on experience. The normalization processing manner includes, but is not limited to, a minimum-maximum normalization manner.

In some embodiments of the present disclosure, by using the temperature data of the first reference vehicle of the target vehicle, the environment reference temperature that filters out interference from external factors such as weather, ground radiation may be determined. By comparing a difference between the temperature information of the battery pack region and the environment reference temperature, only a heating abnormality of the battery pack itself may be retained, thereby reducing false alarms. The thermal risk coefficient may be determined based on the abnormal temperature information of the battery pack region, while simultaneously identifying a plurality of precursors such as short circuits, thermal diffusion, thereby allowing for more accurate risk determination.

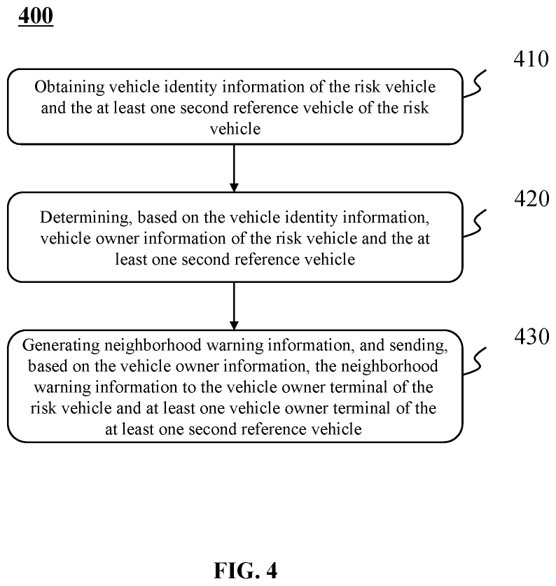

FIG. 4 is a flowchart illustrating an exemplary process for sending early warnings according to some embodiments of the present disclosure. As shown in FIG. 4, a process 400 includes the following steps. In some embodiments, the process 400 may be executed by the emergency supervision management platform 130.

Step 410, obtaining vehicle identity information of the risk vehicle and the at least one second reference vehicle of the risk vehicle.

More descriptions regarding the risk vehicle may be found elsewhere in the present disclosure (e.g., FIG. 2 and related descriptions thereof).

The second reference vehicle refers to a vehicle that may be affected by a thermal runaway risk of the risk vehicle. In some embodiments, the second reference vehicle of the risk vehicle may be another target vehicle within the second neighborhood range of the risk vehicle.

The second neighborhood range refers to an influence range of the thermal runaway risk of the risk vehicle. In some embodiments, the second neighborhood range may be preset manually or use the system default, for example, a circular region centered on the risk vehicle and within a second preset radius range. The first preset radius and the second preset radius may be the same or different.

In some embodiments, the second neighborhood range is related to the thermal risk coefficient of the risk vehicle. The greater the thermal risk coefficient of the risk vehicle, which indicates the higher thermal runaway risk, the greater the second neighborhood range may be.

In some embodiments of the present disclosure, the second neighborhood range is dynamically determined based on the thermal risk coefficient of the risk vehicle, which can allow for adaptive adjustment of an early warning range according to an actual risk level; that is, the higher the risk level (e.g., the higher the thermal risk coefficient), the larger the early warning range. This ensures sufficient safety redundancy in high-risk situations; while avoiding unnecessary disturbance to residents when the risk is low, thereby facilitating intelligent and optimized configuration of early warning resources.

The vehicle identity information refers to identification information capable of characterizing vehicle identity, for example, a license plate number and a vehicle's position. The vehicle's position may be represented by a parking area or a charging pile area where the vehicle is located.

In some embodiments, the emergency supervision management platform may obtain the vehicle identity information via related equipment. For example, the emergency supervision management platform may obtain the license plate number and the vehicle's position, or the like, via monitoring cameras or other camera equipment.

Step 420, determining, based on the vehicle identity information, vehicle owner information of the risk vehicle and the at least one second reference vehicle.

The vehicle owner information may include identity information and contact information of the vehicle owner, which is primarily used for contacting the vehicle owner.

In some embodiments, the emergency supervision management platform may obtain the vehicle owner information by querying the information database based on the vehicle identity information. The information database stores vehicle identity information and corresponding vehicle owner information. For example, the information database may be a database of a charging pile management system in an underground parking lot.

Step 430, generating neighborhood warning information, and sending, based on the vehicle owner information, the neighborhood warning information to the vehicle owner terminal of the risk vehicle and at least one vehicle owner terminal of the at least one second reference vehicle.

The neighborhood warning information refers to relevant information for early warning of the thermal runaway risk of the risk vehicle, which is used to warn the risk vehicle and the second reference vehicle of the risk vehicle. For example, the neighborhood warning information may be “a vehicle with the license plate number of ‘XXX’ has the thermal runaway risk, the owner of the vehicle is requested to stop vehicle charging as soon as possible, the vehicle is located in the No. 1 charging pile area in the west district of the parking lot, and the surrounding vehicles of the vehicle are requested to be moved as soon as possible”, or the like. The form of the neighborhood warning information may include, but is not limited to, early warning short messages, early warning telephone voice messages, or the like.

In some embodiments, the emergency supervision management platform may automatically generate the neighborhood warning information based on a preset information generation template.

In some embodiments, the emergency supervision management platform may send, based on the vehicle owner information, the generated neighborhood warning information to the vehicle owner terminal of the risk vehicle and the at least one vehicle owner terminal of the at least one second reference vehicle. The vehicle owner terminal may include, but is not limited to, a mobile phone, a computer, or the like, of the vehicle owner.

In some embodiments of the present disclosure, by obtaining the vehicle owner information of the risk vehicle and other vehicles adjacent thereto, automatically generating neighborhood warning information, and sending the neighborhood warning information to the vehicle owner terminals, the vehicle owners of the risk vehicle and the adjacent vehicles can take timely measures to prevent the thermal runaway of the risk vehicle from causing larger-scale accidents. This can more comprehensively prevent the occurrence of large-scale thermal runaway accidents, and further improve the safety of the entire preset space.

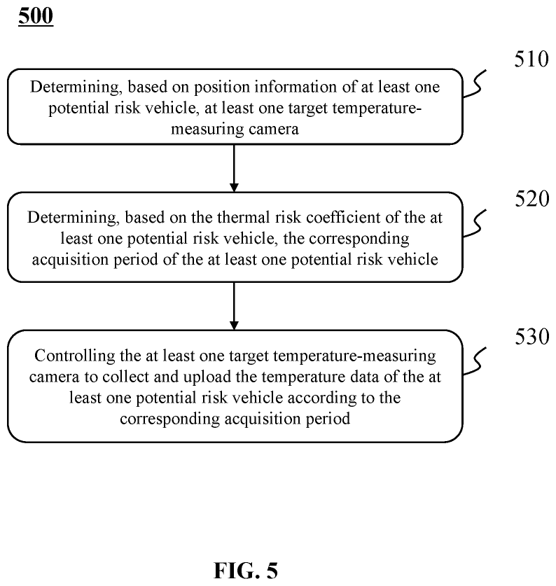

FIG. 5 is a flowchart illustrating an exemplary process for collecting temperature data of at least one potential risk vehicle according to some embodiments of the present disclosure. As shown in FIG. 5, the process 500 includes the following steps. In some embodiments, the process 500 may be performed by the emergency supervision management platform 130.

Step 510, determining, based on position information of at least one potential risk vehicle, at least one target temperature-measuring camera.

The potential risk vehicle refers to a vehicle that may become a risk vehicle in the future and needs to be monitored with focus. In some embodiments, the potential risk vehicle may be a target vehicle whose thermal risk coefficient is greater than a second risk threshold and not greater than a first risk threshold.

More descriptions regarding the first risk threshold may be found elsewhere in the present disclosure (e.g., FIG. 2 and the related descriptions thereof).

The second risk threshold refers to a threshold used to determine the potential risk vehicle and related to the thermal risk coefficient. The second risk threshold is less than the first risk threshold. In some embodiments, the second risk threshold may be preset manually based on experience or set by default by the system.

In some embodiments, the second risk threshold may be related to an environment reference temperature, a battery type, and a state of charge of the potential risk vehicle.

The battery type may include a storage battery and a fuel cell, or the like. In some embodiments, the emergency supervision management platform may identify a vehicle brand and model from vehicle images captured by a camera and determine the battery type through an online query based on the vehicle brand and model.

The state of charge includes not charging (e.g., not connected to a charging pile) and charging (e.g., connected to a charging pile and charging or fully charged). In some embodiments, the emergency supervision management platform may directly obtain the state of charge of the potential risk vehicle based on a charging pile management system or a vehicle bus system through a communication interface (e.g., a CAN bus, Ethernet).

In some embodiments, the emergency supervision management platform may determine an initial second risk threshold corresponding to the potential risk vehicle based on the battery type of the potential risk vehicle by querying a third preset table; determine a state of charge factor based on the state of charge of the potential risk vehicle, including: if the potential risk vehicle is in a not charging state, the corresponding state of charge factor is a preset value less than 1 (e.g., 0.8), and if the potential risk vehicle is in a charging state, the corresponding state of charge factor is 1; determine an environment reference factor based on the environment reference temperature of the potential risk vehicle, including: the environment reference factor being positively correlated with the environment reference temperature and the environment reference factor being represented by a value not greater than 1; and determine the product of the initial second risk threshold, the state of charge factor, and the environment reference factor as the second risk threshold.

The initial second risk threshold refers to an original second risk threshold determined only based on the battery type of a vehicle. The state of charge factor reflects an influence degree of the state of charge of the vehicle on the second risk threshold. The environment reference factor reflects an influence degree of the environment reference temperature on the second risk threshold. The third preset table includes a plurality of battery types and a plurality of corresponding initial second risk thresholds and may be constructed manually in advance. By way of example, the initial second risk threshold of a vehicle whose battery type is a storage battery is lower than the initial second risk threshold of a vehicle whose battery type is a fuel cell.

More descriptions regarding the environment reference temperature may be found elsewhere in the present disclosure (e.g., FIG. 2 and related descriptions thereof).

In some embodiments of the present disclosure, when determining the second risk threshold, the environment reference temperature; the battery type; and the state of charge of the potential risk vehicle are considered, thereby allowing the monitoring intensity for the potential risk vehicles to be more in line with their respective actual risk tolerance (e.g., by adopting a lower risk threshold for battery types with poor thermal stability), further improving the accuracy of personalized monitoring, and reducing misjudgments and missed judgments of the potential risk vehicles.

The position information may be represented by a parking area or a charging pile area where the vehicle is located or may be represented by position coordinates. In some embodiments, the position information of the potential risk vehicle may be obtained based on image information acquired by imaging equipment, through image recognition technology (e.g., road vehicle target detection based on deep learning).

The target temperature-measuring camera refers to a temperature-measuring camera that can clearly capture the battery pack region of the potential risk vehicle.

In some embodiments, the emergency supervision management platform may determine the target temperature-measuring camera by performing spatial calculation based on the shooting range of the temperature-measuring cameras according to the position information of the potential risk vehicle and distribution information of a plurality of temperature-measuring cameras in a preset space.

In some embodiments, the emergency supervision management platform may obtain deployment positions and angle of view ranges of the respective temperature-measuring cameras in the preset space based on a distribution map and factory parameters of the temperature-measuring cameras, and then determine one or more temperature-measuring cameras whose angle of view range can fully cover the battery pack region of the potential risk vehicle as the target temperature-measuring camera through spatial calculation technology. The distribution map and the factory parameters of the temperature-measuring cameras are uploaded manually in advance. The spatial calculation method includes but is not limited to an optical positioning algorithm, a marker-less recognition calculation, an optical and marker-less fusion technology, or the like.

Step 520, determining, based on the thermal risk coefficient of the at least one potential risk vehicle, the corresponding acquisition period of the at least one potential risk vehicle.

The corresponding acquisition period refers to a time interval between two adjacent temperature data collections set for the potential risk vehicle. In some embodiments, the corresponding acquisition period of the potential risk vehicle may be less than the preset acquisition period for all target vehicles described in FIG. 2.

In some embodiments, the corresponding acquisition period of the potential risk vehicle may be related to the thermal risk coefficient of the potential risk vehicle, the greater the thermal risk coefficient, the shorter the corresponding acquisition period.

Step 530, controlling the at least one target temperature-measuring camera to collect and upload the temperature data of the at least one potential risk vehicle according to the corresponding acquisition period.

In some embodiments, the emergency supervision management platform may control the target temperature-measuring camera to collect the temperature data of the potential risk vehicle every corresponding acquisition period and upload the temperature data to the emergency supervision management platform. In a case where there is a plurality of target temperature-measuring cameras, the emergency supervision management platform may select one target temperature-measuring camera closest to the potential risk vehicle to collect temperature data or may perform data fusion on the temperature data collected by the plurality of target temperature-measuring cameras to obtain the final temperature data. Data fusion manner may include but is not limited to averaging, or the like.

The manner of collecting the temperature data of the potential risk vehicle is similar to the manner of collecting the temperature data of the target vehicle. More descriptions may be found in the foregoing step 210 and the related descriptions.

In some embodiments of the present disclosure, by collecting the temperature data of the potential risk vehicle based on the position information and the corresponding acquisition period of the potential risk vehicle, hierarchical monitoring of vehicles with different risk levels can be achieved, that is, focused monitoring is performed on target vehicles with potential risks by increasing the acquisition frequency of temperature data, while conventional monitoring is performed on low-risk vehicles (i.e., non-potential risk vehicles), thereby improving the monitoring accuracy of the potential risk vehicles, achieving efficient utilization of monitoring resources, and refined monitoring of the potential risk vehicles.

The embodiments in the present disclosure are provided merely by way of example and illustration, and do not limit scope of the present disclosure. To those skilled in the art, various modifications and changes that may be made under guidance of the present disclosure remain within the scope of the present disclosure.

Furthermore, certain features, structures, or characteristics in one or more embodiments of the present disclosure may be suitably combined.

In some embodiments, numerical values describing a quantity of ingredients or attributes are used. It should be understood that such numerical values used for description of the embodiments are modified by terms “about”, “approximately”, or “substantially” in some examples. Unless otherwise stated, “about”, “approximately”, or “substantially” indicate that stated numerical values may vary by ±20%. Accordingly, in some embodiments, numerical parameters used in the present disclosure and the claims are all approximate values, which approximate values may vary according to characteristics required by individual embodiments. In some embodiments, the numerical parameters should take into account specified significant digits and adopt a general rounding manner. Although numerical ranges and parameters used to confirm their breadth of scope in some embodiments of the present disclosure are approximate values, in specific embodiments, setting of such numerical values is as precise as possible within a feasible range.

If there are any inconsistencies or conflicts between descriptions, definitions, and/or use of terms in ancillary materials of the present disclosure and content of the present disclosure, the descriptions, definitions, and/or use of terms of the present disclosure shall govern.

What is claimed is:

1. A system for emergency monitoring of parked vehicles based on an Internet of Things (IoT) large model, comprising: an emergency supervision management platform, wherein
the emergency supervision management platform is configured to:
collect, based on at least one temperature-measuring camera, temperature data of at least one target vehicle in a preset space according to a preset acquisition period;
construct, based on the temperature data, a temperature distribution cloud map of the at least one target vehicle;
determine, based on the temperature distribution cloud map, temperature information of at least one battery pack region of the at least one target vehicle;
determine, based on the temperature information, a thermal risk coefficient of the at least one target vehicle;
determine, based on the thermal risk coefficient, at least one risk vehicle;
determine, based on the thermal risk coefficient of the at least one risk vehicle and the temperature data of the at least one risk vehicle, an early warning frequency; and
control at least one warning lamp in a monitoring room to flash at the early warning frequency.

2. The system according to claim 1, wherein the emergency supervision management platform is further configured to:
for each of the at least one target vehicle,
determine, based on the temperature data of at least one first reference vehicle of the target vehicle, an environment reference temperature of the target vehicle, wherein the first reference vehicle is another target vehicle within a first neighborhood range of the target vehicle;
determine, based on the environment reference temperature and the temperature information of the at least one battery pack region, abnormal temperature information of the at least one battery pack region of the target vehicle; and
determine, based on the abnormal temperature information of the at least one battery pack region, the thermal risk coefficient of the target vehicle.

3. The system according to claim 2, wherein the abnormal temperature information further comprises a diffusion path of an abnormal hotspot; and the emergency supervision management platform is further configured to:
determine, based on a plurality of abnormal hotspot centers corresponding to a plurality of time points, the diffusion path of the abnormal hotspot.

4. The system according to claim 3, wherein the plurality of time points comprises a plurality of historical time points and one or more future time points; and the emergency supervision management platform is further configured to:
determine, based on the plurality of abnormal hotspot centers corresponding to the plurality of historical time points, one or more abnormal hotspot centers corresponding to the one or more future time points via a prediction model, wherein the prediction model is a machine learning model.

5. The system according to claim 2, wherein the emergency supervision management platform is further configured to:
for each of the at least one risk vehicle,
obtain vehicle identity information of the risk vehicle and at least one second reference vehicle of the risk vehicle, wherein the second reference vehicle is another target vehicle within a second neighborhood range of the risk vehicle;
determine, based on the vehicle identity information, vehicle owner information of the risk vehicle and the at least one second reference vehicle; and
generate neighborhood warning information, and send, based on the vehicle owner information, the neighborhood warning information to a vehicle owner terminal of the risk vehicle and at least one vehicle owner terminal of the at least one second reference vehicle.

6. The system according to claim 5, wherein the second neighborhood range is related to the thermal risk coefficient of the risk vehicle.

7. The system according to claim 1, wherein the emergency supervision management platform is further configured to:
determine, based on position information of at least one potential risk vehicle, at least one target temperature-measuring camera, wherein the potential risk vehicle is a target vehicle whose a thermal risk coefficient is greater than a second risk threshold and not greater than a first risk threshold;
determine, based on the thermal risk coefficient of the at least one potential risk vehicle, a corresponding acquisition period of the at least one potential risk vehicle; and
control the at least one target temperature-measuring camera to collect and upload the temperature data of the at least one potential risk vehicle according to the corresponding acquisition period.

8. The system according to claim 7, wherein the second risk threshold is related to an environment reference temperature, a battery type, and a state of charge of the at least one potential risk vehicle.

9. A method for emergency monitoring of parked vehicles based on an Internet of Things (IoT) large model, wherein the method is executed by an emergency supervision management platform of a system for emergency monitoring of parked vehicles based on an IoT large model, the method comprising:
collecting, based on at least one temperature-measuring camera, temperature data of at least one target vehicle in a preset space according to a preset acquisition period;
constructing, based on the temperature data, a temperature distribution cloud map of the at least one target vehicle;
determining, based on the temperature distribution cloud map, temperature information of at least one battery pack region of the at least one target vehicle;
determining, based on the temperature information, a thermal risk coefficient of the at least one target vehicle;
determining, based on the thermal risk coefficient, at least one risk vehicle;
determining, based on the thermal risk coefficient of the at least one risk vehicle and the temperature data of the at least one risk vehicle, an early warning frequency; and
controlling at least one warning lamp in a monitoring room to flash at the early warning frequency.

10. The method according to claim 9, wherein the determining the thermal risk coefficient of the at least one target vehicle based on the temperature information includes:
for each of the at least one target vehicle,
determining, based on temperature data of at least one first reference vehicle of the target vehicle, an environment reference temperature of the target vehicle, wherein the first reference vehicle is another target vehicle within a first neighborhood range of the target vehicle;
determining, based on the environment reference temperature and the temperature information of the at least one battery pack region, abnormal temperature information of the at least one battery pack region of the target vehicle; and
determining, based on the abnormal temperature information of the at least one battery pack region, the thermal risk coefficient of the target vehicle.

11. The method according to claim 10, wherein the abnormal temperature information further includes a diffusion path of an abnormal hotspot; and the method further comprises:
determining, based on a plurality of abnormal hotspot centers corresponding to a plurality of time points, the diffusion path of the abnormal hotspot.

12. The method according to claim 11, wherein the plurality of time points includes a plurality of historical time points and one or more future time points; and the method further comprises:
determining, based on a plurality of abnormal hotspot centers corresponding to the plurality of historical time points, one or more abnormal hotspot centers corresponding to the one or more future time points via a prediction model, wherein the prediction model is a machine learning model.

13. The method according to claim 10, wherein the method further comprises:
for each of the at least one risk vehicle,
obtaining vehicle identity information of the risk vehicle and at least one second reference vehicle of the risk vehicle, wherein the second reference vehicle is another target vehicle within a second neighborhood range of the risk vehicle;
determining, based on the vehicle identity information, vehicle owner information of the risk vehicle and the at least one second reference vehicle; and
generating neighborhood warning information, and sending, based on the vehicle owner information, the neighborhood warning information to a vehicle owner terminal of the risk vehicle and at least one vehicle owner terminal of the at least one second reference vehicle.

14. The method according to claim 13, wherein the second neighborhood range is related to the thermal risk coefficient of the risk vehicle.

15. The method according to claim 9, wherein the method further comprises:
determining, based on position information of at least one potential risk vehicle, at least one target temperature-measuring camera, wherein the potential risk vehicle is a target vehicle whose a thermal risk coefficient is greater than a second risk threshold and not greater than a first risk threshold;
determining, based on the thermal risk coefficient of the at least one potential risk vehicle, a corresponding acquisition period of the at least one potential risk vehicle; and
controlling the at least one target temperature-measuring camera to collect and upload the temperature data of the at least one potential risk vehicle according to the corresponding acquisition period.

16. The method according to claim 15, wherein the second risk threshold is related to an environment reference temperature, a battery type, and a state of charge of the at least one potential risk vehicle.

17. A non-transitory computer-readable storage medium storing computer instructions, wherein when a computer reads the computer instructions in the storage medium, the computer executes the method for emergency monitoring of parked vehicles based on the IoT large model according to claim 9.
